(19) United States
(12) Patent Application Publication
(10) Pub. No.: US 2006/0035714 A1
(43) Pub. Date: Feb. 16, 2006

(54) COLLAPSIBLE VEHICLE DRIVESHAFT

(76) Inventors: Yi Qu, Troy, MI (US); Henrik Eldh, Ann Arbor, MI (US); Ray Nicosia, Troy, MI (US); Chris O'Connor, Livonia, MI (US); Phillip Kurrle, Macomb Township, MI (US)

Correspondence Address: BROOKS KUSHMAN P.C./FGTL, 1000 TOWN CENTER, 22ND FLOOR, SOUTHFIELD, MI, 48075-1238, US

(21) Appl. No.: 10/710,945

(22) Filed: Aug. 13, 2004

(51) Int. Cl. F16C 3/03

(52) U.S. Cl. 464/183

(57) ABSTRACT

A collapsible shaft having a unitary tube having an outer portion and a depressed portion dividing the outer portion into two segments. The outer portion has an outer exterior radius (Ro). The depressed portion has a depressed exterior radius (Rd). The Ro is greater than the Rd and the difference between the Ro and Rd is a depressed depth (Dd).

### BACKGROUND OF INVENTION

1. Field of the Invention

One aspect of the present invention generally relates to a vehicle driveshaft, and more specifically, a collapsible vehicle driveshaft tube.

2. Background Art

Torque transmitting shafts are commonly utilized to transfer rotational power from a rotational power source to a rotatably driven mechanism. One such example is a driveshaft tube used in a vehicle driveshaft assembly, which transmits rotational power from a power source, for example an engine, to a rotatably driven mechanism, for example an axle assembly. Typically, a vehicle driveshaft assembly includes a hollow cylindrical driveshaft tube having an end fitting secured to each end thereof. The end fittings can be end yokes adapted to cooperate with universal joints, which provide a rotational driving connection from the output shaft of the rotational power source through the driveshaft tube to the input shaft of the axle assembly. The universal joints also operate to limit the amount of misalignment between the rotational axes of these three shafts. In a specific embodiment, a first universal joint is connected between the output shaft of the rotational power source, for example engine or transmission, and a first end of the driveshaft tube, while a second universal joint is connected between a second end of the driveshaft tube and the input shaft of the driven mechanism, for example an axle assembly.

During a vehicle collision, the driveshaft tube is in a load path between the barrier, for example another vehicle or tree, and the decelerating vehicle. The existence of this load path can increase the magnitude of the crash peak load during the collision. As a result, collapsible drive shaft tubes have been widely utilized that are constructed to be collapsible in an axial direction by plastic deformation of the shaft upon application of an axial force of sufficient magnitude. Generally, the driveshaft tube is formed with one or more regions of reduced axial strength, allowing the shaft to collapse in a controlled and predictable manner in such regions.

One such proposal provides a process for hydroforming a collapsible shaft having torque transmitting splines. According to this proposal, the splined portion of the shaft has an outer diameter that is smaller than an inner diameter of an adjacent portion of the shaft, so that the splined portion can deform into the adjacent portion when the shaft is subjected to an axial force of sufficient magnitude.

Another proposal provides a driveshaft assembly including a male shaft having an outer surface and a female shaft slidably engaged with the male shaft. The shafts absorb energy during axial deformation of the driveshaft while maintaining alignment of the male and female shafts.

According to yet another proposal, a driveshaft assembly is disclosed having an inner driveshaft tube section including an end portion having an outer surface and an outer driveshaft tube section including an end portion having an inner surface. A number of axially extending wires is positioned on either the outer surface of the inner driveshaft tube section or on the inner surface of the outer driveshaft tube section. These sections become deformed so as to compress the wires in between, thereby preventing relative axial and rotational movement during normal operating conditions. However, when a relatively large axial force is applied to the ends of the telescoping driveshaft, the inner driveshaft tube section moves axially within the outer driveshaft tube section, thereby collapsing and absorbing energy.

In light of the forgoing, a collapsible driveshaft is needed that limits peak load, thereby reducing crash peak loads, which is more tuneable, less expensive and/or yields improved crash performance compared to conventional collapsible driveshafts.

### SUMMARY OF THE INVENTION

One embodiment of the present invention is a collapsible driveshaft including a unitary tube having an outer portion and a depressed portion dividing the outer portion into two segments. According to this embodiment, the outer portion has an outer exterior radius (Ro) and the depressed portion has a depressed exterior radius of Rd. The Ro is greater than the Rd and the difference between Ro and Rd is a depressed depth Dd. Accordingly, depressed portion defines an area of structural weakness in the shaft. It is understood that the shaft can be a driveshaft in a vehicle. In certain embodiments, the depressed portion has tapered sides. The depressed portion can have a side (Sd) defined as a longitudinal length between the edges of the outer portion adjoining the depressed portion. The depressed portion can have a longitudinal location (Ld) along the length of the driveshaft and the Ld can be longitudinally centered about the Sd. The first portion can also have a width Wd defined as the longitudinal length between the edges of the tapered sides adjoining the cylindrical surface of the depressed portion. It is understood that in certain embodiments the Ld of the depressed portion is capable of being varied depending on the type of vehicle having the driveshaft. The area of structural weakness thus described is susceptible to bending collapse upon exertion of a substantial force, and is also susceptible to axial collapse upon exertion of a substantial force.

Another embodiment of the present invention is a method of forming a collapsible driveshaft. The method includes denting a unitary tube to form an outer portion and a depressed portion at a location along the length of the unitary tube. The denting thereby divides the outer portion into two segments. The outer portion has an outer exterior radius (Ro) and the depressed portion has a depressed exterior radius (Rd). The Ro is greater than the Rd and the difference between Ro and Rd is the depressed depth Dd. In certain embodiments, the denting step includes placing a depression member at a location along the length of the unitary tube and uniformly denting the depression member in a substantially uniform manner to obtain the depressed portion having the Rd. One example of a depression member is an anulus ring. The anulus ring can have a predetermined radius and predetermined depth for obtaining the Rd and Wd, respectively, upon denting the anulus ring. The method thus described can further include stabilizing the unitary tube prior to the denting step. It is understood that the denting step can be repeated one or more times at different locations to obtain two or more depressed portions in three or more segments of the outer portion.

According to yet another embodiment of the present invention, the collapsible shaft can include a unitary tube having an outer portion and a number of depressed portions Nd longitudinally centered about different longitudinal locations along the length of the tube. The outer portion is thus divided into a number of segments Ns defined as the number of depressed portions plus one, each segment having an outer exterior radius (Rd₁-Rdₙ), and the depressed portions each having a depressed exterior radius where each Ro is greater than each Rd. In certain embodiments, all outer exterior radii are substantially equal. Further, all depressed exterior radii can also be substantially equal. In certain embodiments, the shaft is a driveshaft on a vehicle.

The above and other objects, features, and advantages of the present invention are readily apparent from the following detailed description of the best mode for carrying out the invention when taken in connection with the accompanying drawings.

### BRIEF DESCRIPTION OF THE DRAWINGS

The features of the present invention which are believed to be novel are set forth with particularity in the appended claims. The present invention, both as to its organization and manner of operation, together with further objects and advantages thereof, may best be understood with reference to the following description, taken in connection with the accompanying drawings which:

FIG. 1 is a side elevational view of a vehicle drive train system in accordance with one embodiment of the present invention;

FIG. 2 is a partially broken perspective view of a portion of the collapsible driveshaft assembly depicted in FIG. 1;

FIG. 3 is a sectional elevational view of the collapsible driveshaft taken along line 3-3 of FIG. 2;

FIG. 4 is a partially broken side view of the collapsible driveshaft of FIG. 1; and

FIG. 5 is a graph resulting from an FEA analysis of driveshaft acceleration versus time for a non-collapsible driveshaft and a collapsible driveshaft in accordance with an embodiment of the present invention.

### DETAILED DESCRIPTION OF EMBODIMENTS OF THE PRESENT INVENTION

As required, detailed embodiments of the present invention are disclosed herein. However, it is to be understood that the disclosed embodiments are merely exemplary of the invention that may be embodied in various and alternative forms. Therefore, specific functional details herein are not to be interpreted as limiting, but merely as a representative basis for the claims and/or as a representative basis for teaching one of ordinary skill in the art to variously employ the present invention.

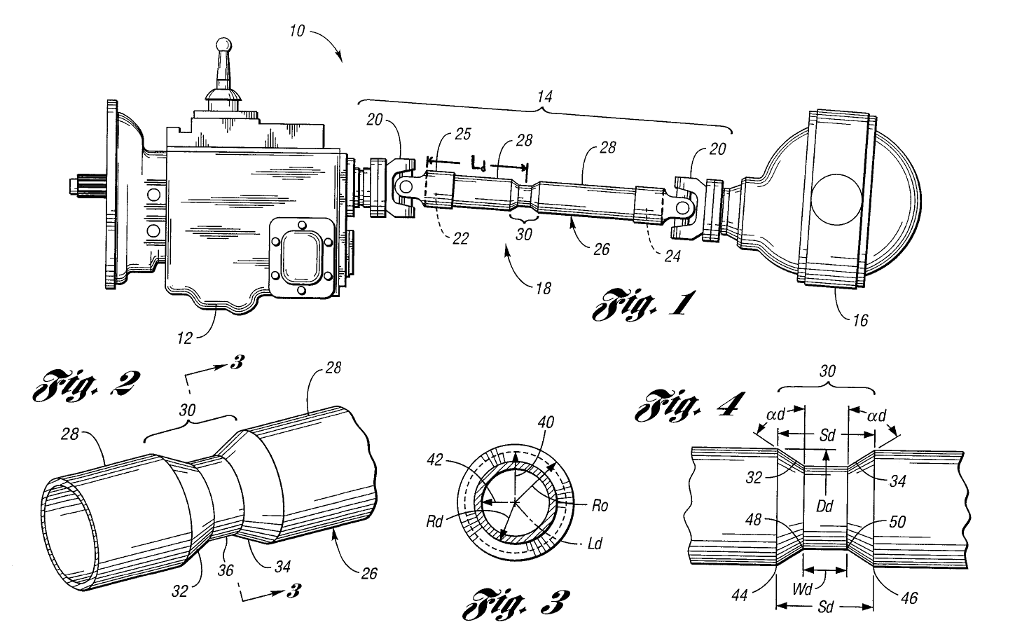

Turning to the drawings, FIG. 1 is a side elevational view of a vehicle drive train system in accordance with one embodiment of the present invention. FIG. 1 depicts a generally conventional vehicle drive train system generally indicated at 10. Drive train system 10 includes transmission 12, driveshaft assembly 14, and axle assembly 16. An output shaft of transmission 12 is connected to an input shaft of axle assembly 16 through driveshaft assembly 14. Driveshaft assembly 14 includes a collapsible driveshaft 18 according to one embodiment of the present invention. Since the transmission output shaft and the axle assembly input shaft are not co-axially aligned in many conventional vehicle drive train systems, universal joints 20 can be provided at the front end 22 and rear end 24 of driveshaft 18 so that driveshaft 18 is rotatably connected at an angle to the output shaft of transmission 12 and the input shaft of axle assembly 16. End fittings 25 are typically attached to ends 22 and 24 of driveshaft 18 to facilitate connections between ends 22 and 24 and universal joints 20. In certain embodiments, end fittings 25 can be slip or tube yokes.

Having thus described one generally conventional vehicle drive train system, it should be understood that the system can be varied within the scope of the present invention. For example, the drive train system can include a number (N) of driveshaft assemblies and N+1 universal joints. In a specific embodiment, two driveshaft assemblies, each having an end fitting on each end, can be connected to three universal joints, i.e. a left and right universal joint and a central universal joint.

Referring to FIGS. 1 and 2, collapsible driveshaft 18, according to one embodiment of the present invention includes unitary tube 26 having outer portion 28 and depressed portion 30. In certain embodiments, unitary tube is generally cylindrical and elongated. Depressed portion 30 includes tapered sides 32 and 34 and depressed exterior surface 36. In certain embodiments, tapered sides 32 and 24 are substantially planar, although the sides can be curved depending on the manufacturing process used to form depressed portion 20. In certain embodiments, depressed exterior surface 36 is substantially cylindrical, although the surface can take on different shapes depending on the manufacturing process used to form depressed portion 20. Typically, unitary tube 26 is formed from steel or aluminum alloy. However, other materials, such as fiber reinforced composites or other combinations of metallic or non-metallic materials, can also be used.

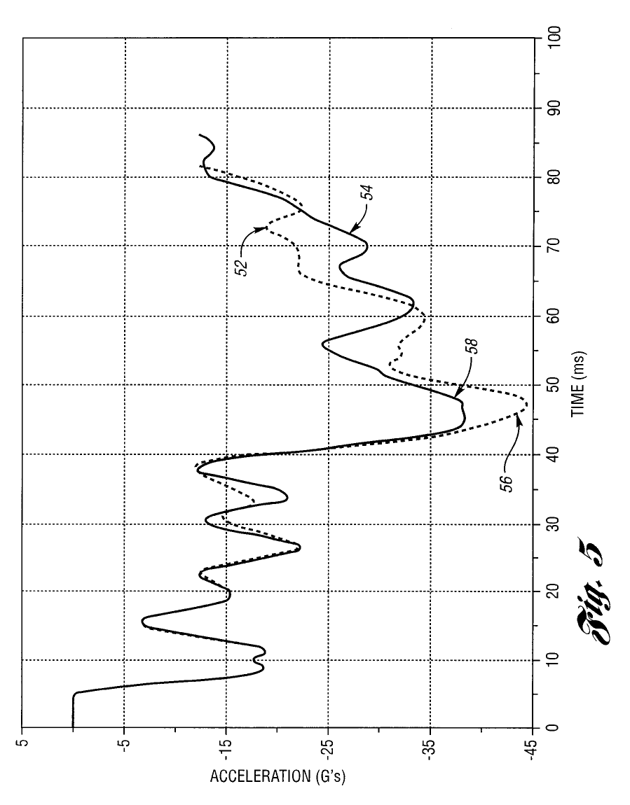

Depressed portion 30 can be formed through any process suitable for denting unitary tube 26 to obtain depressed portion 30. In certain embodiments, the denting process provides substantial uniformity of depression diameter and side tapering, although an amount of eccentricity is acceptable for purposes of practicing the present invention. According to one embodiment of the present invention, the denting step is accomplished by placing a depression member around unitary tube 26, longitudinally centered at a location along the length of unitary tube 26. As shown in FIGS. 1 and 3, Ld is an example of a suitable location. In certain embodiments, the depression member is an anulus ring. The depression member is dented to obtain the depressed portion. In certain embodiments, the denting step can be carried out by any suitable process that provides suitable uniformity of the depressed member. One such exchange is hammer-forming wherein a number of hammers apply perpendicular force upon the depression member at a number of different circumferential locations of the depression. Optionally, the unitary tube can be stabilized prior to denting step, by, for example, placing the unitary tube in a vice grip and tightening the vice grip around the unitary tube.

Referring now to FIGS. 2, 3, and 4, collectively, outer portion 28 has outer exterior radius Ro and outer interior radius 40, the difference between these two values being the thickness of outer portion 28, which in certain embodiments is between about 0.025 inches and 0.200 inches. In certain embodiments, Ro is between about 0.6 inches and 3.0 inches. Depressed portion 30 has depressed exterior radius Rd and depressed interior radius 42. The difference between these two values represents the thickness of depressed portion 30, which in certain embodiments is between about 0.025 inches and 0.200 inches. In certain embodiments, Rd is between about 0.4 inches and 2.5 inches. As depicted in FIG. 3, Ro is greater than Rd, making the depressed portion an area of structural weakness in tube 26. This area is susceptible to bending collapse upon exertion of a substantial force, and this area is also susceptible to axial collapse to relatively lesser extent. As depicted in FIG. 4, the difference between Ro and Rd is depressed depth Dd. In certain embodiments, Dd is in the range of about 0.2 inches to 3.0 inches.

According to FIG. 4, sides 32 and 34 have taper angle αd. In certain embodiments, αd is between about 20 degrees and 60 degrees. Depressed portion 30 has a size dimension Sd which is defined as the longitudinal length between the edges 44 and 46 of the outer portion adjoining depressed portion 30. In certain embodiments, Sd is between about 0.5 inches and 5.0 inches. Depressed portion 30 also has a width dimension Wd which is defined as the longitudinal length between the edges 48 and 50 of tapered sides 32 and 34 adjoining the cylindrical surface of the depressed portion. In certain embodiments, Wd is between about 0.0 inches (representing a V-shaped profile consisting of two tapered sides) and 5.0 inches.

In the embodiments thus described, one depressed portion is formed in the tubular member. However, it should be understood that more than one depressed portion can be formed based on the vehicle using the collapsible driveshaft. In one such embodiment, the collapsible driveshaft includes a unitary tube having an outer portion and a number of depressed portions (Nd) longitudinally centered about different longitudinal locations along the length of the tube, thereby dividing the outer portion into a number of segments (Ns) defined as the number of depressed portions plus one, each segment having an outer exterior radius (Ro₁-Roₙ), the depressed portions each having a depressed exterior radius (Rd₁-Rdₙ), each Ro being greater than each Rd. In certain embodiments, all the depressed exterior radii are substantially equal and/or all outer exterior radii are substantially equal.

Having thus described the parameters of depressed portion 30, i.e. Ld, Rd, Dd, Sd, αd, and Wd, these parameters can be varied for application in different vehicle parameters, thus providing a collapsible driveshaft that is tuneable for a wide variety of vehicles. Non-limiting examples of vehicle parameters include longitudinal engine transfer, north/south engine alignment, engine accessory stack up, vehicle mass, wheel drive (i.e. all wheel/rear wheel), and number of driveshafts in transmission assembly.

In one example, a collapsible driveshaft in accordance with the present invention can be formed for a vehicle having all wheel drive. A tubular member, used on the collapsible driveshaft, can be dented to form a depressed portion having the approximate parameter values disclosed in Table 1. In this example, the length of the tubular member is about 32.4 inches and the location (Ld) of the longitudinal center of the depressed portion is measured from the end of the tubular member closest to the transmission. The outer exterior radius (Ro) for this example is about 1.2 inches.

TABLE 1

| Parameter | Value |
|---|---|
| Ld | 9.3 inches |
| Rd | 1.0 inches |
| Dd | 0.2 inches |
| Sd | 1.0 inches |
| αd | 39 degrees |
| Wd | 0.4 inches |

Using these parameters, a dented tubular member was formed to provide a collapsible driveshaft for an FEA crash simulation. Crash simulations were carried out to test the efficacy of the collapsible driveshaft. In a first simulation, a vehicle was programmed with two non-collapsible driveshafts. The vehicle was then subjected to a simulated full frontal crash at 35 mph. In a second simulation, the same vehicle was programmed with one non-collapsible driveshaft and one collapsible driveshaft in accordance with an embodiment of the present invention. The collapsible driveshaft was located closest to the transmission. The vehicle with the collapsible driveshaft was also subjected to a simulated full frontal crash at 35 mph.

FIG. 5 graphically depicts the results of these simulations, wherein the y-axis of the graph is acceleration in Gs and the x-axis is time in milliseconds from simulated impact. The dotted curve 52 depicts the controlled trial and the solid curve 54 depicts the test trial using the collapsible driveshaft. The peak Gs for the controlled simulation is about 45, as depicted by curve segment 56. The peak Gs for the simulations using the collapsible driveshaft is about 39, as depicted by curve segment 58, thereby delivering a reduction in peak Gs of 6. It should be understood that this is but one example of how the present invention can be implemented.

While the best mode for carrying out the invention has been described in detail, those familiar with the art to which this invention relates will recognize various alternative designs and embodiments for practicing the invention as defined by the following claims.

1. A collapsible shaft comprising:
a unitary tube having an outer portion and a depressed portion dividing the outer portion into two segments, the outer portion having an outer exterior radius (Ro), the depressed portion having a depressed exterior radius (Rd), the Ro being greater than the Rd, and the difference between Ro and Rd being a depressed depth (Dd).

2. The collapsible shaft of claim 1 wherein the depressed portion defines an area of structural weakness in the shaft.

3. The collapsible shaft of claim 1 wherein the shaft is a driveshaft.

4. The collapsible shaft of claim 3 wherein the depressed portion has tapered sides.

5. The collapsible shaft of claim 4 wherein the depressed portion has a size (Sd) defined as the longitudinal length between the edges of the outer portion adjoining the depressed portion.

6. The collapsible shaft of claim 5 wherein the depressed portion has a longitudinal location (Ld) along the length of the driveshaft and the Ld is longitudinally centered about the Sd.

7. The collapsible shaft of claim 4 wherein the depressed portion has a width (Wd) defined as the longitudinal length between the edges of the tapered sides adjoining the cylindrical surface of the depressed portion.

8. The collapsible shaft of claim 5 wherein the Ld of the depressed portion is capable of being varied depending on the type of vehicle having the driveshaft.

9. The collapsible shaft of claim 2 wherein the area of structural weakness is susceptible to bending collapse upon exertion of a substantial force.

10. The collapsible shaft of claim 2 wherein the area of structural weakness is susceptible to axial collapse upon exertion of a substantial force.

11. A method of forming a collapsible shaft comprising:
denting a unitary tube to from an outer portion and a depressed portion at a location along the length of the unitary tube, thereby dividing the outer portion into two segments, the outer portion having an outer exterior radius (Ro), the depressed portion having a depressed exterior radius (Rd), the Ro being greater than the Rd, and the difference between Ro and Rd being a depressed depth (Dd).

12. The method of claim 11 wherein the denting step is comprised of:
placing a depression member at the location and around the unitary tube; and
denting the depression member in a substantially uniform manner to obtain the depressed portion having the Rd.

13. The method of claim 12 wherein the depression member is an anulus ring.

14. The method of claim 13 wherein the anulus ring has a predetermined radius and a predetermined depth for obtaining the Rd and Wd, respective, upon denting the anulus ring.

15. The method of claim 11 further comprising stabilizing the unitary tube prior to the denting step.

16. The method of claim 11 wherein the denting step is repeated one or more times at different locations to obtain two or more depressed portions and three or more segments of the outer portion.

17. A collapsible shaft comprising:
a unitary tube having an outer portion and a number of depressed portions (Nd) longitudinally centered about different longitudinal locations along the length of the tube, thereby dividing the outer portion into a number of segments (Ns) defined as the number of depressed portions plus one, each segment having an outer exterior radius (Ro₁-Roₙ), the depressed portions each having a depressed exterior radius (Rd₁-Rdₙ), each Ro being greater than each Rd.

18. The collapsible shaft of claim 17 wherein all outer exterior radii are substantially equal.

19. The collapsible shaft of claim 17 wherein all depressed exterior radii are substantially equal.

20. The collapsible shaft of claim 17 the shaft is a driveshaft.
